(19) United States
(12) Patent Application Publication
(10) Pub. No.: US 2026/0092804 A1
(43) Pub. Date: Apr. 2, 2026

(54) DEVICES AND METHODS FOR REPLACING TESTED FLOW METER IN LIQUID HYDROGEN FLOW MEASUREMENT STANDARD FACILITY

(71) Applicant: CHINA JILIANG UNIVERSITY, Hangzhou (CN)

(72) Inventors: Fubing BAO, Hangzhou (CN); Chengxu TU, Hangzhou (CN); Yexin LU, Hangzhou (CN); Yalei ZHAO, Hangzhou (CN); Xiang LI, Hangzhou (CN); Pengfei DU, Hangzhou (CN); Jinghao ZHANG, Hangzhou (CN); Mingyang ZHANG, Hangzhou (CN)

(73) Assignee: CHINA JILIANG UNIVERSITY, Hangzhou (CN)

(21) Appl. No.: 19/414,248

(22) Filed: Dec. 9, 2025

Related U.S. Application Data
(63) Continuation of application No. PCT/CN2024/094327, filed on May 21, 2024.

(30) Foreign Application Priority Data
Nov. 7, 2023 (CN) 202311472422.4

(51) Int. Cl. G01F 25/10; F17C 5/04; F17C 13/02; G01F 15/18

(52) U.S. Cl. CPC G01F 25/10; F17C 5/04; F17C 13/02; G01F 15/185; F17C 2221/012; F17C 2223/0161; F17C 2223/0169; F17C 2227/039; F17C 2227/045; F17C 2250/036; F17C 2250/0443

(57) ABSTRACT

Disclosed is a device and method for quickly replacing a tested flow meter in a liquid hydrogen flow measurement standard facility. The present disclosure includes a tested cold box, wherein the tested flow meter is located in the evacuated tested cold box, the tested cold box is connected to the liquid hydrogen flow measurement standard facility through a bayonet structure; a first vacuum pump, configured to evacuate the tested cold box after replacing the tested flow meter; a second vacuum pump, configured to evacuate a tested pipeline; a precooling device, configured to precool the tested pipeline and the tested flow meter connected to the tested pipeline after the tested pipeline is evacuated.

### CROSS-REFERENCE TO RELATED APPLICATIONS

This application is a Continuation of International Application No. PCT/CN2024/094327, filed on May 21, 2024, which claims priority to Chinese Patent Application No. 202311472422.4, filed on Nov. 7, 2023, the entire contents of each of which are hereby incorporated by reference.

### TECHNICAL FIELD

The present disclosure generally relates to a field of hydrogen energy technology, and in particular to a device and a method for quickly connecting a tested unit to a liquid hydrogen flow measurement standard facility.

### BACKGROUND

Hydrogen is a clean, efficient, and zero-carbon energy carrier with diverse sources, which serves as both a fuel and a raw material in fields such as heating, transportation, industry, and power generation. The hydrogen holds an important position in the current energy system, which is also an important medium for achieving conversion between various energy types such as electricity, heat, and liquid fuels. Meanwhile, hydrogen energy also plays an important role and contributes positively to the realization of the grand goal of global low-carbon emissions.

In a hydrogen energy industry chain, the hydrogen exists primarily in two states in different application scenarios: high-pressure gaseous hydrogen and cryogenic liquid hydrogen. The volumetric energy density of the liquid hydrogen is much greater than that of high-pressure gaseous hydrogen. Compared to the high-pressure gaseous hydrogen, the liquid hydrogen has more obvious advantages in storage and long-distance transportation, and its development prospects are promising. The liquid hydrogen is a cryogenic, low-viscosity, high-efficiency fluid fuel. However, a boiling point of the liquid hydrogen is extremely low, making it very easy to vaporize. This places higher requirements on the insulation, safety, and operational convenience of devices during the liquid hydrogen measurement and transfer process.

Difficulties in using liquid hydrogen for real-flow verification includes that: in previous devices, the insulation measures for key components such as pipelines, flow meters, and liquid hydrogen pumps were relatively scattered, resulting in a high risk of heat leakage. It was difficult to maintain the pipeline in a fully liquid state, which could not meet the actual needs of liquid hydrogen flow measurement. Alternatively, the insulation measures for key components such as pipelines, flow meters, and liquid hydrogen pumps were highly integrated into a single cold box. This meant that each time a flow meter was replaced after inspection, the cold box had to be opened, causing the pre-cooling and vacuum inside the cold box to fail. Simultaneously, this caused the vacuum inside the test pipeline to fail. After replacement, it was necessary to re-evacuate the inside of the cold box and the pipeline, and re-pre-cool the cold box and its internal components. Furthermore, due to the extremely low boiling point of liquid hydrogen, the pre-cooling temperature of the device is extremely low. This resulted in significant consumption of time and energy after each replacement.

### SUMMARY

To address the above deficiencies, the present disclosure provides a device for quickly replacing a tested flow meter in a liquid hydrogen flow measurement standard facility.

To achieve the above objective, to ensure stable adiabatic performance of the overall liquid hydrogen flow standard facility, simplify an overall operation process for replacing the tested flow meter, and save time during the replacement process, the technical solution of the present disclosure is as follows:

One or more embodiments of the present disclosure provide a device for quickly replacing a tested flow meter in a liquid hydrogen flow measurement standard facility, the device comprises: a tested cold box, wherein the tested flow meter is located in a vacuum tested pipeline cold box, and the tested pipeline cold box is connected to the liquid hydrogen flow measurement standard facility through a bayonet structure; a first vacuum pump, configured to evacuate the tested pipeline cold box after replacing the tested flow meter; a second vacuum pump, configured to evacuate a tested pipeline; wherein the tested pipeline is a pipeline formed by connecting a first vacuum bellow, an inlet pipe of a tested pipeline cold box, a supporting pipeline of the tested flow meter, an outlet pipe of the tested pipeline cold box, and a second vacuum bellow in series; a first liquid hydrogen refueling coupler female connector and a second liquid hydrogen refueling coupler female connector are respectively connected to the first vacuum bellow and the second vacuum bellow through flanges to form a liquid hydrogen standard flow during calibration; a connector on the second vacuum pump is in a form of a liquid hydrogen refueling coupler male connector, and the connector on the second vacuum pump is connected to the first liquid hydrogen refueling coupler female connector when evacuating the tested pipeline; a precooling device, configured to precool the tested pipeline and the tested flow meter connected to the tested pipeline after the tested pipeline is evacuated.

One or more embodiments of the present disclosure provide a method for quickly replacing a tested flow meter, applicable to a liquid hydrogen flow measurement standard facility, using the above device, the method comprises: after completing calibration of a tested flow meter and before calibrating a next tested flow meter, disconnecting a tested pipeline cold box from the liquid hydrogen flow measurement standard facility through a bayonet structure; after replacing the tested flow meter and a supporting pipeline, evacuating the tested pipeline cold box; evacuating a tested pipeline; and precooling the tested pipeline and the tested flow meter connected to the tested pipeline.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating a top view of an overall structure of a device for quickly replacing a tested flow meter in a liquid hydrogen flow measurement standard facility according to some embodiments of the present disclosure.

FIG. 2 is a schematic diagram illustrating an overall structure of a device for quickly replacing a tested flow meter in a liquid hydrogen flow measurement standard facility according to some embodiments of the present disclosure.

FIG. 3 is a schematic diagram illustrating a front view of a tested cold box after a flange cover is opened according to some embodiments of the present disclosure.

FIG. 4 is a schematic diagram illustrating an exemplary process for vacuum pumping and precooling of a tested pipeline according to some embodiments of the present disclosure.

FIG. 5 is a schematic flowchart illustrating an exemplary process for quickly replacing a tested flow meter according to some embodiments of the present disclosure.

FIG. 6 is a schematic flowchart illustrating an exemplary process for stopping vacuum pumping according to some embodiments of the present disclosure.

FIG. 7 is a schematic diagram illustrating an exemplary prediction model according to some embodiments of the present disclosure.

### REFERENCE NUMERALS DESCRIPTION

liquid hydrogen storage tank A unit 1, pipeline cold box unit 2, liquid hydrogen storage tank B and weighing unit 3, tested flow meter quick cut-in unit 4, gas source and gas special discharge unit 5, liquid hydrogen storage tank A 101, pipeline cold box 201, pipeline cold box inlet 202, pipeline cold box liquid phase port 203, pipeline cold box gas phase port 204, pipeline cold box purge gas source interface 205, first liquid hydrogen pump 206, pipeline cold box liquid return outlet 207, refrigerator 208, tested pipeline cold box 401, inlet pipe 402 of the tested pipeline cold box, outlet pipe 403 of the tested pipeline cold box, first vacuum bellow 404, second vacuum bellow 405, first liquid hydrogen refueling coupler 406, second liquid hydrogen refueling coupler 407, first vacuum sleeve tube 408, second vacuum sleeve tube 409, square flange cover 410, structural combination of the tested flow meter 411-1, structural combination of the tested flow meter 411-2, structural combination of the tested flow meter 411-3, tested flow meter 411-1-1, tested flow meter 411-2-1, tested flow meter 411-3-1, supporting pipeline 411-1-2, supporting pipeline 411-2-2, supporting pipeline 411-3-2, first vacuum pump 412, first pressure sensor 413, second pressure sensor 414, first temperature sensor 415, second temperature sensor 416, liquid hydrogen storage tank B 301, high-precision weighing unit 302, second vacuum pump 601, solenoid valve 602, second liquid hydrogen pump 701, large liquid hydrogen storage tank 702.

### DETAILED DESCRIPTION

The present disclosure is further described below in conjunction with the accompanying drawings and embodiments.

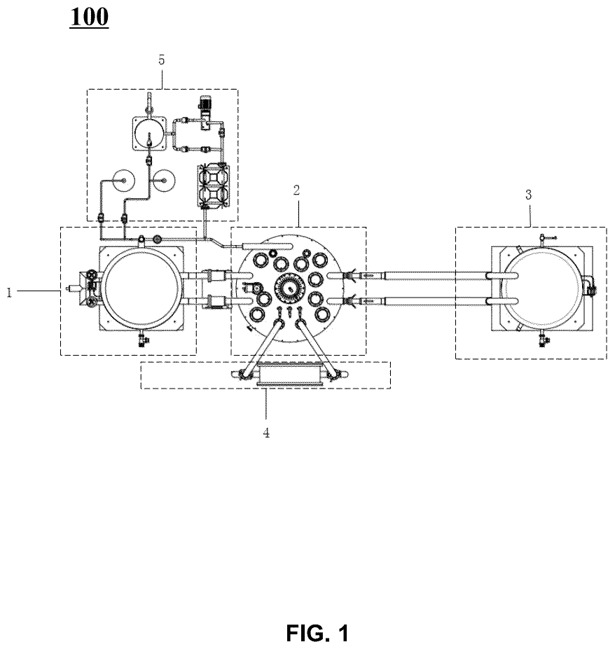

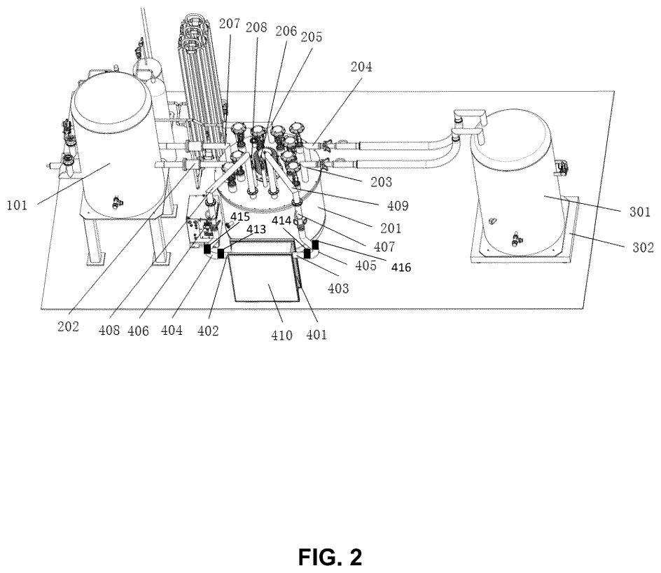

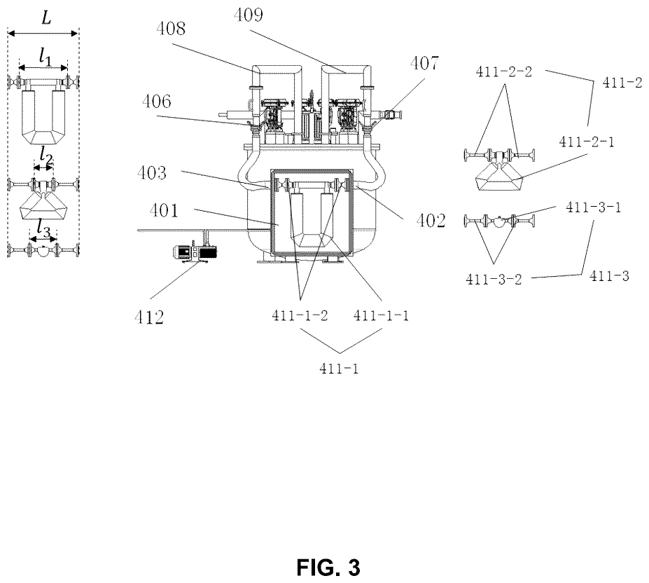

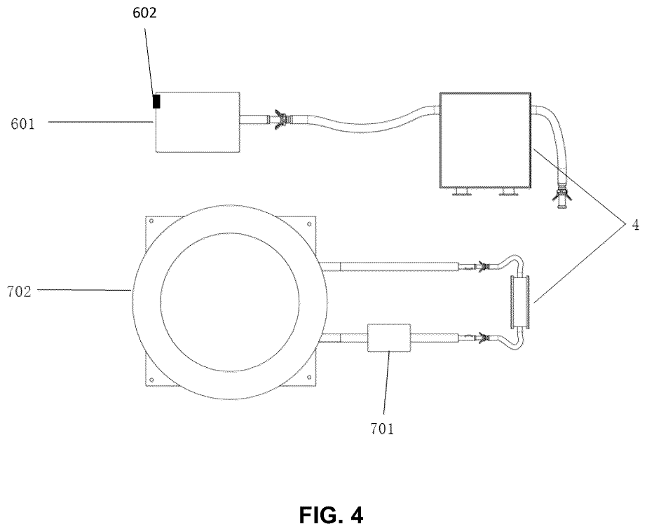

FIG. 1 is a schematic diagram illustrating a top view of an overall structure of a device for quickly replacing a tested flow meter in a liquid hydrogen flow measurement standard facility according to some embodiments of the present disclosure. FIG. 2 is a schematic diagram illustrating an overall structure of a device for quickly replacing a tested flow meter in a liquid hydrogen flow measurement standard facility according to some embodiments of the present disclosure. FIG. 3 is a schematic diagram illustrating a front view of a tested cold box after a flange cover is opened according to some embodiments of the present disclosure. FIG. 4 is a schematic diagram illustrating an exemplary process for vacuum pumping and precooling of a tested pipeline according to some embodiments of the present disclosure.

Embodiments of the present disclosure provide a device for quickly replacing a tested flow meter in a liquid hydrogen flow measurement standard facility (hereinafter referred to as a device 100). The device 100 includes: a tested cold box, wherein the tested flow meter is located in the evacuated tested cold box, and the tested cold box is connected to the liquid hydrogen flow measurement standard facility through a bayonet structure; a first vacuum pump, configured to evacuate the tested cold box after replacing the tested flow meter; a second vacuum pump, configured to evacuate a tested pipeline; wherein the tested pipeline is a pipeline formed by connecting a first vacuum bellow, an inlet pipe of a tested pipeline cold box, a supporting pipeline of the tested flow meter, an outlet pipe of the tested pipeline cold box, and a second vacuum bellow in series; a first liquid hydrogen refueling coupler female connector and a second liquid hydrogen refueling coupler female connector are respectively connected to the first vacuum bellow and the second vacuum bellow through flanges to form a liquid hydrogen standard flow during calibration; a connector on the second vacuum pump is in a form of a liquid hydrogen refueling coupler male connector, and the connector on the second vacuum pump is connected to the first liquid hydrogen refueling coupler female connector when evacuating the tested pipeline; a precooling device, configured to precool the tested pipeline and the tested flow meter connected to the tested pipeline after the tested pipeline is evacuated.

A form of the liquid hydrogen refueling coupler male connector includes a structure of an insertion end of a bayonet structure.

The tested cold box refers to a container for accommodating the tested flow meter and a supporting pipeline of the tested flow meter. The tested cold box may also be referred to as the tested pipeline cold box.

The liquid hydrogen flow measurement standard facility refers to a facility for performing standard calibration on a liquid hydrogen flow meter (i.e., the tested flow meter). The device 100 refers to a device for calibrating, verifying, or replacing a liquid hydrogen flow meter.

The tested flow meter refers to a flow meter that is undergoing or scheduled to undergo verification or calibration.

As shown in FIG. 1 to FIG. 4, the device 100 includes: a liquid hydrogen storage tank A unit 1, a pipeline cold box unit 2, a liquid hydrogen storage tank B and weighing unit 3, a tested flow meter quick cut-in unit 4, and a gas source and gas special discharge unit 5.

The liquid hydrogen storage tank A unit 1 stores liquid hydrogen and provides a liquid hydrogen source for the calibration process. In some embodiments, as shown in FIG. 2, the liquid hydrogen storage tank A unit 1 includes a liquid hydrogen storage tank A 101. The liquid hydrogen storage tank A 101 refers to a device for storing hydrogen in liquid form.

In some embodiments, as shown in FIG. 2, the pipeline cold box unit 2 includes: a pipeline cold box 201, a pipeline cold box inlet 202, a pipeline cold box liquid phase port 203, a pipeline cold box gas phase port 204, a pipeline cold box purge gas source port 205; a first liquid hydrogen pump 206, a pipeline cold box liquid return outlet 207, and a refrigerator 208.

The pipeline cold box 201 refers to a device for precooling pipelines and providing and maintaining a low-temperature insulation environment.

The pipeline cold box inlet 202 refers to an inlet for liquid hydrogen to enter the pipeline cold box from the liquid hydrogen storage tank A 101.

The pipeline cold box liquid phase port 203 refers to an outlet for subcooled liquid hydrogen to flow out of the pipeline cold box unit 2 and enter the liquid hydrogen storage tank B 301.

The pipeline cold box gas phase port 204 refers to an opening connected to the gas source and gas special discharge unit 5.

In some embodiments, as shown in FIG. 2, the liquid hydrogen storage tank B and the weighing unit 3 include: a liquid hydrogen storage tank B 301 and a high-precision weighing unit 302.

The high-precision weighing unit 302 refers to a device for accurately measuring the mass of liquid hydrogen in the storage tank.

In some embodiments, as shown in FIG. 2 and FIG. 3, the tested flow meter quick cut-in unit 4 includes: a tested pipeline cold box 401, an inlet pipe 402 of the tested pipeline cold box, an outlet pipe 403 of the tested pipeline cold box, a first vacuum bellow 404, a second vacuum bellow 405, a first liquid hydrogen refueling coupler 406, a second liquid hydrogen refueling coupler 407, a first vacuum sleeve tube 408, a second vacuum sleeve tube 409, a square flange cover 410, a first vacuum pump 412, or the like.

In some embodiments, the first vacuum pump 412 is configured to evacuate the tested pipeline cold box 401 after replacing the tested flow meter.

The tested pipeline cold box 401 is configured to provide a vacuum insulation environment for the tested flow meter and the supporting pipeline of the tested flow meter.

In some embodiments, as shown in FIG. 3, a structural combination 411-1 of the tested flow meter includes a tested flow meter 411-1-1 and a supporting pipeline 411-1-2. The structural combination 411-1 of the tested flow meter may be disposed inside the tested pipeline cold box 401. In some embodiments, the supporting pipeline is used to adapt to different models of tested flow meters, so that a total length of the tested flow meter remains at a preset value. For example, the preset value of the total length of different tested flow meters and respective supporting pipelines of the tested flow meters may all be L. More descriptions regarding the preset value of the total length may be found in the descriptions related to FIG. 3 below.

In some embodiments, different models of the tested flow meters are configured with different supporting pipelines. For example, as shown in FIG. 3, a structural combination 411-2 of the tested flow meter includes a tested flow meter 411-2-1 and a corresponding supporting pipeline 411-2-2; a structural combination 411-3 of the tested flow meter includes a tested flow meter 411-3-1 and a corresponding supporting pipeline 411-3-2.

In some embodiments, as shown in FIG. 2, the pipeline cold box 201 is connected to the liquid hydrogen storage tank A 101 through the pipeline cold box inlet 202, and the pipeline cold box 201 is connected to the liquid hydrogen storage tank B 301 through the pipeline cold box liquid phase port 203. The pipeline cold box 201 is configured to provide a vacuum insulation environment for a main pipeline through which liquid hydrogen flows, and to maintain a low-temperature environment. The pipeline cold box inlet 202 and the pipeline cold box liquid phase port 203 are located on the pipeline cold box 201.

The pipeline cold box gas phase port 204 and the pipeline cold box purge gas source interface 205 are located on the pipeline cold box 201. The pipeline cold box gas phase port 204 and the pipeline cold box purge gas source interface 205 cooperate to perform purging or gas replacement inside the pipeline cold box 201.

The first liquid hydrogen pump 206 is located on an internal pipeline of the pipeline cold box 201. The first liquid hydrogen pump 206 is configured to provide power for liquid hydrogen flow and to pump a calibration flow.

The pipeline cold box liquid return outlet 207 is located on the pipeline cold box 201. The pipeline cold box liquid return outlet 207 refers to a pipeline outlet for the liquid hydrogen to return from the liquid hydrogen storage tank B 301 to the liquid hydrogen storage tank A 101 after calibration is completed.

The refrigerator 208 is connected to an internal pipeline of the pipeline cold box 201, and is configured to further cool the liquid hydrogen in the pipeline to ensure that the liquid hydrogen remains in a stable liquid state.

In some embodiments, as shown in FIG. 2, the liquid hydrogen storage tank B 301 is configured to receive and store the liquid hydrogen that flows through during the calibration process.

The high-precision weighing unit 302 is located below the liquid hydrogen storage tank B 301, and is configured to accurately measure a weight difference of the liquid hydrogen storage tank B 301 before and after calibration, to obtain an actual weight of the liquid hydrogen that flowed through the tested flow meter.

In some embodiments, as shown in FIG. 2, the tested pipeline cold box 401 is connected to the pipeline cold box unit 2 of the liquid hydrogen flow measurement standard facility through a connector. For example, the tested pipeline cold box 401 is connected to the liquid hydrogen flow measurement standard facility through a bayonet structure. The bayonet structure (also referred to as a bayonet connector or quick connector, etc.) refers to a mechanical structure for connecting and disconnecting fluid pipelines. The tested pipeline cold box 401 provides an independent vacuum insulation environment for a structural combination of a tested flow meter (including the tested flow meter and the supporting pipeline).

An inlet pipe 402 of the tested pipeline cold box and an outlet pipe 403 of the tested pipeline cold box are located inside the tested pipeline cold box 401. The inlet pipe 402 of the tested pipeline cold box is connected to the first vacuum bellow 404. The outlet pipe 403 of the tested pipeline cold box is connected to the second vacuum bellow 405. The inlet pipe 402 of the tested pipeline cold box refers to a pipeline through which liquid hydrogen flows into the tested pipeline cold box 401. The outlet pipe 403 of the tested pipeline cold box is a pipeline through which liquid hydrogen flows out of the tested pipeline cold box 401.

The first vacuum bellow 404 is connected to a first liquid hydrogen refueling coupler 406. The second vacuum bellow 405 is connected to a second liquid hydrogen refueling coupler 407. The first vacuum bellow 404 and the second vacuum bellow 405 are configured to achieve flexible connection to compensate for installation errors and to maintain the vacuum insulation environment.

In some embodiments, each of the first liquid hydrogen refueling coupler 406 and the second liquid hydrogen refueling coupler 407 includes a male connector (including a protruding structure) and a female connector (including a recessed structure). Merely by way of example, each of the first liquid hydrogen refueling coupler 406 and the second liquid hydrogen refueling coupler 407 includes the bayonet structure.

In some embodiments, the male connector of the first liquid hydrogen refueling coupler 406 is connected to a first vacuum sleeve tube 408. The female connector of the first liquid hydrogen refueling coupler 406 is connected to the first vacuum bellow 404. The male connector of the second liquid hydrogen refueling coupler 407 is connected to a second vacuum sleeve tube 409. The female connector of the second liquid hydrogen refueling coupler 407 is connected to the second vacuum bellow 405. The male connector and the female connector of the first liquid hydrogen refueling coupler 406 and the second liquid hydrogen refueling coupler 407 are configured to achieve rapid connection or disconnection between the tested pipeline cold box 401 and a main pipeline.

In some embodiments, the female connector of the first liquid hydrogen refueling coupler 406 and the female connector of the second liquid hydrogen refueling coupler 407 are respectively connected to the first vacuum bellow 404 and the second vacuum bellow 405 through flanges. The female connector of the first liquid hydrogen refueling coupler 406 and the female connector of the second liquid hydrogen refueling coupler 407 are configured to form a liquid hydrogen standard flow during calibration.

The flanges refer to components disposed between pipelines for connection and sealing.

The calibration refers to a process of comprehensively inspecting and testing the metrological performance of a measuring instrument (e.g., a flow meter, etc.).

The liquid hydrogen standard flow refers to a reference benchmark flow used to calibrate a flow meter.

A square flange cover 410 is disposed on the tested pipeline cold box 401. Disposing the square flange cover 410 facilitates opening and closing the tested pipeline cold box 401 to efficiently replace the internal tested flow meter and the supporting pipeline.

A first vacuum pump 412 is connected to the tested pipeline cold box 401 through an interface. The first vacuum pump 412 is configured to evacuate the interior of the tested pipeline cold box 401, where the tested flow meter is located, after replacing the tested flow meter, to restore the vacuum insulation environment.

In some embodiments, as shown in FIG. 2, a gas source and gas special discharge unit 5 is connected to a pipeline cold box unit 2 through interfaces (e.g., a pipeline cold box gas phase port 204, a pipeline cold box purge gas source port 205, etc.). The gas source and gas special discharge unit 5 is configured to provide a purge gas source and handle discharged gas to purge the device 100 before calibration, thereby removing moisture and impurities.

In some embodiments, a second vacuum pump 601 is configured to evacuate a tested pipeline to remove moisture, gas, or other impurities, from the tested pipeline. A connector on the second vacuum pump 601 has a structure similar to that of the male connector of the first liquid hydrogen refueling coupler. When evacuating the tested pipeline, the connector on the second vacuum pump 601 is connected to the female connector of the first liquid hydrogen refueling coupler 406.

The tested pipeline refers to a pipeline through which liquid hydrogen flows in the liquid hydrogen flow measurement standard facility.

In some embodiments, the tested pipeline is a pipeline formed by connecting the first vacuum bellow 404, the inlet pipe 402 of the tested pipeline cold box, the supporting pipeline of the tested flow meter, the outlet pipe 403 of the tested pipeline cold box, and the second vacuum bellow 405 in series.

In some embodiments, by using the tested pipeline and performing the evacuation process, the tested flow meter may be quickly placed in the vacuum insulation environment, improving calibration efficiency.

A precooling device refers to a device for cooling down the tested pipeline or the flow meter.

The precooling device is configured to precool the tested pipeline and the tested flow meter connected to the tested pipeline after the tested pipeline is evacuated.

In some embodiments, as shown in FIG. 4, the device 100 may further include: the second vacuum pump 601, a large liquid hydrogen storage tank 702, and a second liquid hydrogen pump 701.

In some embodiments, the large liquid hydrogen storage tank 702 may provide a liquid hydrogen source for precooling the tested pipeline without consuming liquid hydrogen from a liquid hydrogen storage tank A 101 or a liquid hydrogen storage tank B 301. The large liquid hydrogen storage tank 702 may be temporarily connected to the tested pipeline during a precooling phase. Merely by way of example, the large liquid hydrogen storage tank 702 may include a storage tank with a volume greater than 1 cubic meter, or the like.

The second liquid hydrogen pump 701 is installed on a precooling loop. The precooling loop includes a temporary pipeline when the large liquid hydrogen storage tank 702 is temporarily connected to the tested pipeline. The second liquid hydrogen pump 701 is configured to pump liquid hydrogen from the large liquid hydrogen storage tank 702 into the tested pipeline during the precooling phase to achieve cyclic precooling.

The present disclosure provides a tested pipeline that may be independently disconnected or connected by a user. The tested flow meter and the supporting pipeline of the tested flow meter may be integrated into the tested pipeline cold box 401. After the tested flow meter is connected to the supporting pipeline, it is connected to the inlet pipe 402 of the tested pipeline cold box and the outlet pipe 403 of the tested pipeline cold box. Simultaneously, the first liquid hydrogen refueling coupler 406 and the second liquid hydrogen refueling coupler 407 are used to connect the tested pipeline to an overall pipeline.

Connecting the components described in the present disclosure in the manner shown in FIG. 1 to FIG. 4 enables a person skilled in the art to successfully implement the device of the present disclosure. The device 100 of the present disclosure mainly includes a liquid hydrogen storage tank A unit 1, a pipeline cold box unit 2, a liquid hydrogen storage tank B and weighing unit 3, a tested flow meter quick cut-in unit 4, and the gas source and gas special discharge unit 5.

The tested flow meter quick cut-in unit 4 includes the tested pipeline cold box 401, the first vacuum bellow 404, the second vacuum bellow 405, the first liquid hydrogen refueling coupler 406, the second liquid hydrogen refueling coupler 407, a first vacuum sleeve tube 408, and a second vacuum sleeve tube 409.

In some embodiments, the tested flow meter and the supporting pipeline are connected to the inlet pipe of the tested cold box and the outlet pipe of the tested cold box using the flanges.

In some embodiments, a first liquid hydrogen refueling coupler female male connector and a second liquid hydrogen refueling coupler male connector are connected to the pipeline cold box in the liquid hydrogen flow measurement standard facility through respective vacuum sleeve tubes.

The first liquid hydrogen refueling coupler female male connector may also be referred to as the first liquid hydrogen refueling coupler male connector.

In some embodiments of the present disclosure, an upstream end of the vacuum sleeve tube 408 is connected to a pipeline cold box liquid return outlet 207 of the pipeline cold box unit 2. A downstream end of the first vacuum sleeve tube 408 is connected to the first liquid hydrogen refueling coupler 406. An upstream end of the second vacuum sleeve tube 409 is connected to the second liquid hydrogen refueling coupler 407. A downstream end of the second vacuum sleeve tube 409 is connected to a pipeline cold box liquid inlet 202 of the pipeline cold box unit 2. The male connector of the first liquid hydrogen refueling coupler 406 is connected to the first vacuum sleeve tube 408. The female connector of the first liquid hydrogen refueling coupler 406 is connected to the first vacuum bellow 404. The male connector of the second liquid hydrogen refueling coupler 407 is connected to the second vacuum sleeve tube 409. The female connector of the second liquid hydrogen refueling coupler 407 is connected to the second vacuum bellow 405. An upstream end of the first vacuum bellow 404 is connected to the first liquid hydrogen refueling coupler 406. A downstream end of the first vacuum bellow 404 is connected to the inlet pipe 402 of the tested pipeline cold box. An upstream end of the second vacuum bellow 405 is connected to the outlet pipe 403 of the tested pipeline cold box. A downstream end of the second vacuum bellow 405 is connected to the second liquid hydrogen refueling coupler 407. The inlet pipe 402 of the tested pipeline cold box is connected to the first vacuum bellow 404. The outlet pipe 403 of the tested pipeline cold box is connected to the second vacuum bellow 405. An upstream end of the tested flow meter and the supporting pipeline of the tested flow meter (e.g., a structural combination of the tested flow meter 411-1) is connected to the inlet pipe 402 of the tested pipeline cold box. A downstream end of the tested flow meter and the supporting pipeline of the tested flow meter are connected to the outlet pipe 403 of the tested pipeline cold box.

In some embodiments, the tested pipeline cold box 401 includes an interface configured to connect to the first vacuum pump 412. The tested pipeline cold box 401 is sealed with a square flange cover 410 to facilitate disassembly and assembly.

As shown in FIG. 2, before calibration of the device 100, the liquid hydrogen flow measurement standard facility is connected to the gas source and gas special discharge unit 5 through a pipeline cold box gas phase port 204 of the pipeline cold box 201 and a pipeline cold box purge gas source port 205 of the pipeline cold box 201. This connection is configured to cooperate with the gas source port and the gas source and gas special discharge unit 5 to purge the liquid hydrogen flow measurement standard facility.

In some embodiments, in response to entering a flow meter calibration phase, the liquid hydrogen flows out of the liquid hydrogen storage tank A 101. The liquid hydrogen enters the pipeline cold box 201 through a pipeline cold box liquid inlet 202 of the pipeline cold box 201. The liquid hydrogen is then pumped by the first liquid hydrogen pump 206 and flows through the tested pipeline. The tested pipeline includes, in sequence, the first vacuum sleeve tube 408, the first liquid hydrogen refueling coupler 406, the first vacuum bellow 404, the inlet pipe 402 of the tested pipeline cold box, the supporting pipeline of the tested flow meter, the outlet pipe 403 of the tested pipeline cold box, the second vacuum bellow 405, the second liquid hydrogen refueling coupler 407, and the second vacuum sleeve tube 409. The liquid hydrogen then returns to the pipeline cold box 201. The refrigerator 208 further subcools the liquid hydrogen to ensure liquid phase stability. The liquid hydrogen then flows into the liquid hydrogen storage tank B 301, which already contains some liquid hydrogen, through a pipeline cold box liquid phase port 203 of the pipeline cold box 201. In some embodiments, the high-precision weighing unit 302 is located below the liquid hydrogen storage tank B 301. The high-precision weighing unit 302 is configured to measure the mass of the liquid hydrogen in the liquid hydrogen storage tank B 301 before calibration starts and after calibration ends. After calibration ends, the liquid hydrogen in the liquid hydrogen storage tank B 301 enters the pipeline cold box 201 through the pipeline cold box liquid phase port 203 of the pipeline cold box 201. The liquid hydrogen flows through the internal pipeline of the pipeline cold box 201 and enters the liquid hydrogen storage tank A unit 1 through a pipeline cold box liquid return outlet 207 of the pipeline cold box 201 to complete the test.

In some embodiments, a plurality of tested flow meters are connected through respective supporting pipelines. A total length of each tested flow meter and corresponding supporting pipeline is the same as a reserved pipeline length in the tested pipeline cold box. This configuration enables calibration of flow meters from different manufacturers within the same caliber range.

In some embodiments, a total length of each tested flow meter and the corresponding supporting pipeline is the same as a reserved pipeline length in the tested pipeline cold box.

The reserved pipeline refers to a reserved pipeline gap in the liquid hydrogen flow measurement standard facility. Merely by way of example, the length of the reserved pipeline may be L.

The caliber range refers to a size range of an inner diameter of the tested flow meter.

As shown in FIG. 3, the tested flow meters 411-1-1, 411-2-1, and 411-3-1 in the present embodiment include common low-temperature flow meter models on the market. Required installation lengths for an inlet and an outlet at two ends corresponding to the tested flow meter are 11, 12, and 13, respectively. After being connected to the respective supporting pipelines 411-1-2, 411-2-2, and 411-3-2 through flanges, the total lengths are all L. These total lengths are equal to the length L of the reserved pipeline in the tested pipeline cold box 401. For example, a structural combination length of the tested flow meter 411-1-1 and the supporting pipeline 411-1-2 is L. A structural combination length of the tested flow meter 411-2-1 and the supporting pipeline 411-2-2 is L. A structural combination length of the tested flow meter 411-3-1 and the supporting pipeline 411-3-2 is L. The structural combinations 411-1, 411-2, and 411-3 of the tested flow meters (i.e., the structural combinations of the tested flow meters and the supporting pipelines) enable calibration of flow meters from different manufacturers within the same caliber range.

For various types of small-caliber flow meters, the tested cold box enables connection to the tested pipeline through non-standard design and manufacturing of the supporting pipelines. This configuration enables one facility to test different types and sizes of low-temperature flow meters.

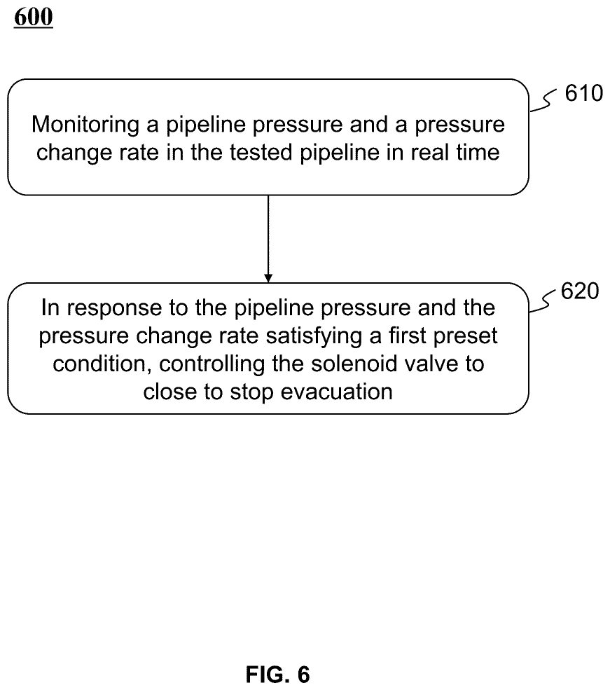

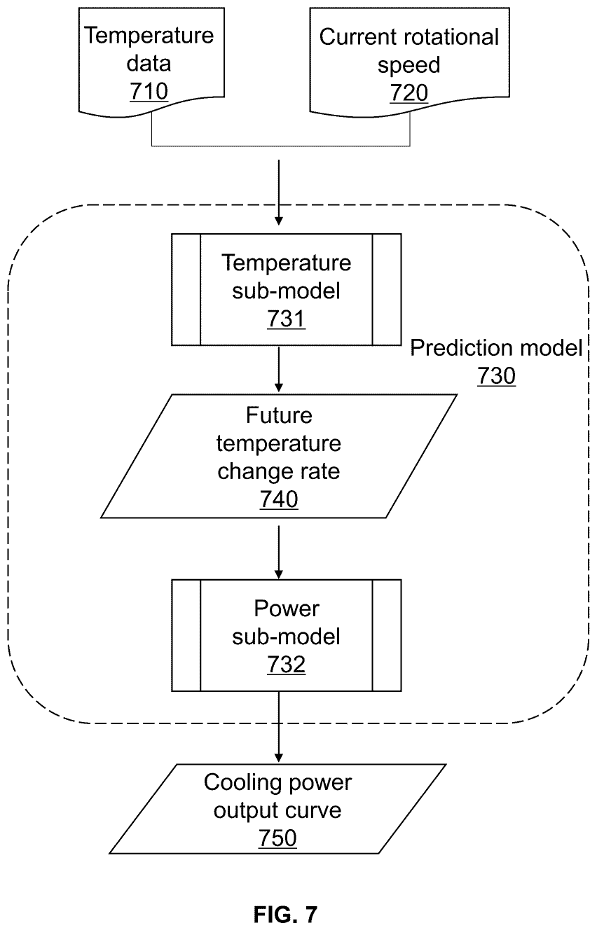

In some embodiments, as shown in FIG. 1 to FIG. 4, the device 100 may further include a first pressure sensor 413, a second pressure sensor 414, a first temperature sensor 415, a second temperature sensor 416, a solenoid valve 602, or the like. More descriptions may be found in FIG. 6, FIG. 7, and related descriptions.

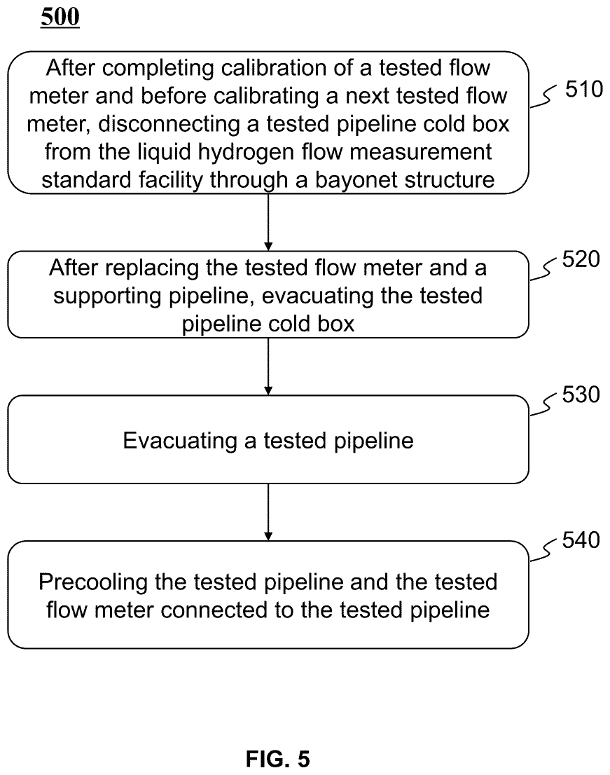

FIG. 5 is a schematic flowchart illustrating an exemplary process for quickly replacing a tested flow meter according to some embodiments of the present disclosure.

The present disclosure provides a method for quickly replacing a tested flow meter. The method is applicable to a liquid hydrogen flow measurement standard facility. The method includes: after completing calibration of a tested flow meter and before calibrating a next tested flow meter, disconnecting a tested pipeline cold box from the liquid hydrogen flow measurement standard facility through a bayonet structure; after replacing the tested flow meter and a supporting pipeline, evacuating the tested pipeline cold box; evacuating a tested pipeline; and precooling the tested pipeline and the tested flow meter connected to the tested pipeline.

In some embodiments, after completing calibration of a tested flow meter 411-1-1 and before starting calibration of a next tested flow meter 411-2-1, the first liquid hydrogen refueling coupler 406 and the second liquid hydrogen refueling coupler 407 are disconnected. The square flange cover 410 is opened. At this time, a cavity in the tested pipeline cold box 401 is exposed to air. The cavity, the tested flow meter 411-1-1, and the supporting pipeline 411-1-2 heat up quickly. This facilitates removal of the tested flow meter 411-1-1 and the supporting pipeline 411-1-2. After removal, a pre-assembled next tested flow meter 411-2-1 and the supporting pipeline 411-2-2 are connected to the tested pipeline. The square flange cover 410 is reclosed. The first vacuum pump 412 evacuates the interior of the tested pipeline cold box 401.

As shown in FIG. 5, the process 500 includes operation 510 to operation 540:

In 510, after completing calibration of a tested flow meter and before calibrating a next tested flow meter, disconnecting a tested pipeline cold box from the liquid hydrogen flow measurement standard facility through a bayonet structure.

In some embodiments, an operator may perform the disconnection through the bayonet structure in various ways. For example, a connector is rotated by 90 degrees for locking to form a sealed liquid hydrogen flow path, or the like. For disconnection, the connector is rotated in a reverse direction to unlock and separate the connector.

More descriptions regarding the tested flow meter, the tested pipeline cold box, the liquid hydrogen flow measurement standard facility, the bayonet structure may be found in FIG. 1 to FIG. 4 and related descriptions.

In some embodiments, disconnecting the tested pipeline cold box 401 from the liquid hydrogen flow measurement standard facility through the bayonet structure includes: disconnecting a male connector and a female connector of the first liquid hydrogen refueling coupler 406 and the second liquid hydrogen refueling coupler 407 in the liquid hydrogen flow measurement standard facility.

In the embodiments of the present disclosure, both the first liquid hydrogen refueling coupler 406 and the second liquid hydrogen refueling coupler 407 have the bayonet structure. During the disconnection, the male connector of the first liquid hydrogen refueling coupler 406 is disconnected from the first vacuum sleeve tube 408. The male connector of the second liquid hydrogen refueling coupler 407 is disconnected from the second vacuum sleeve tube 409. The female connector of the first liquid hydrogen refueling coupler 406 is disconnected from the first vacuum bellow 404. The female connector of the second liquid hydrogen refueling coupler 407 is disconnected from the second vacuum bellow 405. The male connector and the female connector of the liquid hydrogen refueling coupler are self-sealing to maintain their respective vacuum.

In 520, after replacing the tested flow meter and a supporting pipeline, evacuating the tested pipeline cold box.

In some embodiments, after the operator replaces the tested flow meter 411-1-1 and the supporting pipeline 411-1-2, the first vacuum pump 412 is configured to evacuate the interior of the tested cold box. This ensures the tested flow meter 411-1-1 is in a vacuum insulation environment.

In 530, evacuating a tested pipeline.

In some embodiments, the tested pipeline is exposed to air during replacement of the tested flow meter 411-1-1 and the supporting pipeline 411-1-2. The tested pipeline needs to be evacuated before reconnection to remove residual gas, moisture, etc., to avoid affecting measurement accuracy.

Evacuation of the tested pipeline is achieved by connecting a second vacuum pump 601 to a first liquid hydrogen refueling coupler female connector on the tested pipeline through a bayonet structure. A connector form of the second vacuum pump 601 is the same as a male connector of the first liquid hydrogen refueling coupler. The first liquid hydrogen refueling coupler female connector on the tested pipeline may serve as both a liquid hydrogen inlet and a vacuum pumping port, achieving interface reuse.

In some embodiments, the operator may add a pressure sensor on the tested pipeline and add a solenoid valve 602 on the pipeline of the second vacuum pump 601. A pressure condition inside the tested pipeline is monitored in real time. A first preset condition and a second preset condition are preset to determine whether the evacuation process is complete. When pressure data inside the tested pipeline satisfies the first preset condition and the second preset condition, the solenoid valve 602 of the second vacuum pump 601 is automatically closed. This avoids over-evacuation or system freezing, etc. More description regarding the pressure sensor, the second vacuum pump, the solenoid valve, the first preset condition, and the second preset condition may be found in FIG. 6 and related descriptions.

In 540, precooling the tested pipeline and the tested flow meter connected to the tested pipeline.

After the tested pipeline is evacuated and before liquid hydrogen is introduced, the tested pipeline needs to be cooled to prevent substantial vaporization of the liquid hydrogen.

In some embodiments, the operator may connect the tested pipeline cold box 401 to an independent precooling circuit. A second liquid hydrogen pump 701 is started to pump liquid hydrogen into the tested pipeline for circulation cooling.

In some embodiments, the precooling manner is: the tested pipeline cold box is connected to both sides of a large liquid hydrogen storage tank 702. The liquid hydrogen is pumped into the tested pipeline by the second liquid hydrogen pump 701 on the pipeline.

As shown in FIG. 4, after evacuation of the interior of the tested pipeline cold box 401 is completed, the female connector of the first liquid hydrogen refueling coupler 406 is connected to the male connector of the bayonet structure of the second vacuum pump 601. Evacuation of the internal pipelines of the first vacuum bellow 404, the inlet pipe 402 of the tested pipeline cold box, the tested flow meter and the supporting pipeline, the outlet pipe 403 of the tested pipeline cold box, and the second vacuum bellow 405 begins. When a required vacuum degree is reached, the tested cold box is connected to both sides of the large liquid hydrogen storage tank 702. The second liquid hydrogen pump 701 on the pipeline pumps liquid hydrogen into the aforementioned pipelines to precool the aforementioned pipelines.

The large liquid hydrogen storage tank refers to a facility that provides cooling capacity and a liquid hydrogen source for the independent precooling circuit. A volume of the liquid hydrogen storage tank may be determined by the operator according to cooling requirements. For example, the volume of the liquid hydrogen storage tank may be determined to be 2000 L, or the like.

A structural design of the tested flow meter quick cut-in unit 4 ensures that the process of replacing the tested flow meter 411-1-1 with the tested flow meter 411-2-1 does not affect a vacuum state inside the pipeline cold box 201 or a low-temperature state inside the pipeline cold box 201. This solution also ensures that evacuation only needs to be performed on the tested pipeline cold box 401 and the tested pipeline. Precooling only needs to be performed on the tested flow meter 411-2-1 and the tested pipeline. Compared to evacuating and precooling the large facility of the pipeline cold box 201, these two processes have a simpler structure and more convenient operation. The shorter loop enables better evacuation and precooling effects. This can significantly shorten a large amount of detection interval time and reduce consumption of a large amount of cooling medium.

The tested cold box retains a vacuum pump interface, enabling self-evacuation of the interior of the tested pipeline cold box after disconnection from the overall pipeline, without needing to evacuate together with the overall facility. Simultaneously, a vacuum state inside the tested pipeline is achieved by connecting the male connector of the first vacuum pump to the first liquid hydrogen refueling coupler female connector and then evacuating the tested pipeline. The connection structure is the bayonet structure, which is convenient for plugging and unplugging. The time required to evacuate the tested pipeline is far less than the time required to evacuate the overall pipeline, greatly shortening calibration preparation time.

After precooling is completed, the male connector and the female connector of the first liquid hydrogen refueling coupler 406 and the second liquid hydrogen refueling coupler 407 are respectively connected. This connects the tested pipeline to the pipeline inside the pipeline cold box. Calibration of the next tested flow meter 411-2-1 may then be performed.

In some embodiments of the present disclosure, a tested pipeline is precooled by disconnecting it from an overall pipeline and connecting it to a precooling loop. The second liquid hydrogen pump 701 is used to pump liquid hydrogen from a large liquid hydrogen storage tank 702 to individually precool the tested pipeline. This avoids waste of precooling medium caused by the need to precool the overall pipeline after replacing a tested flow meter.

In the embodiments of the present disclosure, a first liquid hydrogen refueling coupler 406 and a second liquid hydrogen refueling coupler 407 both have the bayonet structure. The bayonet structure includes a male connector and a female connector. The male connector of the first liquid hydrogen refueling coupler 406 and the second liquid hydrogen refueling coupler 407 are connected to the first vacuum sleeve tube 408 and a second vacuum sleeve tube 409 respectively through the flanges. The female connectors of the first liquid hydrogen refueling coupler 406 and the second liquid hydrogen refueling coupler 407 are connected to the first vacuum bellow 404 and the second vacuum bellow 405 respectively through the flanges. The structure with the male connector on top and the female connector at the bottom may maximize self-sealing of both ends of the liquid hydrogen refueling coupler to maintain their respective vacuums.

In the embodiments of the present disclosure, the tested flow meter and the supporting pipeline of the tested flow meter are connected to the inlet pipe 402 of the tested pipeline cold box and the outlet pipe 403 of the tested pipeline cold box through the flanges. This facilitates disassembly and replacement of the tested flow meter and the supporting pipeline of the tested flow meter. It also sufficiently supports the working weight of the flow meter and the supporting pipeline of the tested flow meter. It avoids heat exchange caused by contact between the flow meter and a cold box shell through a support mechanism.

In some embodiments of the present disclosure, a tested pipeline may be quickly connected to or disconnected from the overall pipeline. When replacing a flow meter after a single calibration of the flow meter, there is no need to open a pipeline cold box. This maintains the vacuum inside the pipeline cold box. It also maintains the low-temperature state of the overall pipeline without change. After replacing the flow meter, it is only necessary to evacuate a tested cold box, and then evacuate and precool the tested pipeline. After the male connector and the female connector of the first liquid hydrogen refueling coupler 406 and the second liquid hydrogen refueling coupler 407 are connected respectively, the calibration process on the tested flow meter may be performed. This greatly reduces the time and energy consumption for calibrating a plurality of different flow meters.

FIG. 6 is a schematic flowchart illustrating an exemplary process for stopping vacuum pumping according to some embodiments of the present disclosure. As shown in FIG. 6, a process 600 includes operation 610 and operation 620. The process 600 may be performed by a first controller.

In 610, monitoring a pipeline pressure and a pressure change rate in the tested pipeline in real time.

In some embodiments, as shown in FIG. 2, a device 100 may further include a pressure sensor (e.g., a first pressure sensor 413 and a second pressure sensor 414). The first pressure sensor 413 is disposed on an inlet pipe of a tested pipeline cold box 402. The second pressure sensor 414 is disposed on an outlet pipe 403 of the tested pipeline cold box.

In some embodiments, the first pressure sensor 413 and the second pressure sensor 414 are configured to monitor the pipeline pressure and the pressure change rate in the tested pipeline in real time.

In some embodiments, a plurality of pressure sensors are provided. The plurality of pressure sensors are distributed and disposed at at least two positions among an inlet pipe 402 of the tested pipeline cold box, within a preset distance of the tested flow meter, and an outlet pipe 403 of the tested pipeline cold box.

The preset distance refers to a distance of a pipeline opening of the tested flow meter relative to a pipeline opening of the supporting pipeline, such as 5 cm, or the like.

In some embodiments, the preset distance is preset by a user.

In some embodiments of the present disclosure, by disposing the plurality of pressure sensors on an inlet pipe, an outlet pipe, and within a preset distance of the tested flow meter, pressure and pressure changes at different points in the tested pipeline may be accurately monitored. A pressure drop at an inlet and an outlet of the tested flow meter may be accurately obtained. This allows for comprehensive understanding and evaluation of performance of the tested flow meter. It ensures high precision and reliability of liquid hydrogen calibration results. In addition, through pressure monitoring at a plurality of positions, the device 100 may not only accurately determine whether vacuum pumping is completed, but also diagnose whether there is a local leak. When a pressure at a certain point is abnormal, an alarm may be issued in advance. This avoids putting a pipeline with a leakage risk into a subsequent low-temperature precooling process. It prevents safety hazards caused by ice blockage or pressure accumulation.

The pipeline pressure refers to a pressure of a fluid (e.g., liquid hydrogen) inside a pipeline, such as 0.003 MPa, or the like.

The pressure change rate refers to a change in the pipeline pressure per unit time, such as 0.5 MPa/min, or the like.

In 620, in response to the pipeline pressure and the pressure change rate satisfying a first preset condition, controlling the solenoid valve to close to stop evacuation.

In some embodiments, as shown in FIG. 4, a liquid hydrogen flow measurement standard facility further includes a solenoid valve 602 and a first controller (not shown in the figure). The solenoid valve 602 is disposed on a pipeline of a second vacuum pump 601. The first controller is communicatively connected to the first pressure sensor 413, the second pressure sensor 414, and the solenoid valve 602.

In some embodiments, the first controller is configured to: in response to the pipeline pressure and the pressure change rate satisfying a first preset condition, control the solenoid valve 602 to close to stop evacuation.

The solenoid valve 602 is used to control the opening and closing of a pipeline for vacuum pumping or gas charging/venting, or the like.

The first controller refers to a device capable of performing data processing, analysis, calculation, and data transmission/reception. For example, the first controller may be a Programmable Logic Controller (PLC), a central processing unit (CPU), or the like. The first controller may receive data uploaded by the first pressure sensor 413, the second pressure sensor 414, and the solenoid valve 602, and analyze these data.

The first preset condition refers to a judgment condition for stopping vacuum pumping related to a pipeline pressure and a pressure change of the tested pipeline cold box 401. The first preset condition may be preset by a user.

In some embodiments, the first preset condition may include that the pipeline pressure is higher than a target pressure value and the pressure change rate is lower than a rate change threshold. The target pressure value and the rate change threshold may be values preset by a user. For example, the target pressure value may be 10\hat{ }−5 Pa, and the rate change threshold may be 10 Pa/min, etc.

In some embodiments, the target pressure value may be determined by consulting a pressure table based on a sealing performance of the tested pipeline and an ultimate pumping capacity of a second vacuum pump 601. The rate change threshold may be determined by consulting a pressure table based on a volume size of the tested pipeline, a pumping speed of the second vacuum pump 601, and a desired vacuum pumping response time, or the like.

The pressure table includes target pressure values corresponding to different sealing performances of tested pipelines and ultimate pumping capacities of different vacuum pumps. It also includes rate change thresholds corresponding to different volume sizes of the tested pipelines, different pumping speeds of vacuum pumps, and different desired vacuum pumping response times. The pressure table may be constructed based on historical data. For example, when a vacuum degree in a tested pipeline satisfies a preset vacuum threshold, a mean value of historical pressures corresponding to the same or similar sealing performances of the tested pipelines and ultimate pumping capacities of vacuum pumps in the historical data may be used as the target pressure value in the pressure table. A mean value of historical pressure change rates corresponding to the same or similar volume sizes of the tested pipelines, pumping speeds of vacuum pumps, and desired vacuum pumping response times may be used as the rate change threshold in the pressure table.

In some embodiments, the volume size of the tested pipeline, the pumping speed of the vacuum pump, the desired vacuum pumping response time, the sealing performance of the tested pipeline, and the ultimate pumping capacity of the vacuum pump may be input into the first controller by a user.

In some embodiments, the first controller is further configured to: in response to a plurality of pipeline pressures and a plurality of pressure change rates monitored by the plurality of pressure sensors satisfying the first preset condition, control the solenoid valve 602 to close to stop the evacuation.

For example, when the plurality of pipeline pressures are all higher than the target pressure value and the plurality of pressure change rates are all lower than the rate change threshold, the first controller may control the solenoid valve 602 to close to stop the evacuation.

In some embodiments of the present disclosure, by setting dual control based on an absolute pressure value and a change rate, it may be intelligently and reliably confirmed that the tested pipeline reaches a deep vacuum and has good air tightness. This improves the efficiency and automation level of vacuum pumping. It ensures the purity and stability of the liquid hydrogen calibration medium, guaranteeing measurement accuracy. By monitoring the pressure change rate, the evacuation process may be intelligently optimized, automatically stopping at a performance inflection point where efficiency drops sharply. This not only avoids ineffective operation and saves electrical energy, but also reduces high-load idling of the vacuum pump, significantly extending the service life of the equipment.

In some embodiments, the device 100 further includes a user terminal (not shown in the figure). The user terminal is configured to push an abnormal alarm message to a user. The first controller is further configured to: in response to the plurality of pipeline pressures and the plurality of pressure change rates satisfying a second preset condition, trigger the first controller to send the abnormal alarm message to the user terminal.

The user terminal refers to a terminal that interacts with a user. For example, the user terminal may include an electronic screen, a display board, a computer, a mobile phone, or the like.

The user terminal may be communicatively connected to the first controller.

The abnormal alarm message refers to warning information that reflects a pressure abnormality. As an example, the abnormal alarm message may include a location where the abnormality occurs and/or a location of a pressure sensor that monitors the abnormal data, etc.

The second preset condition refers to a condition related to determining whether to issue the abnormal alarm message. The second preset condition may be preset by the user.

The second preset condition may be that a pipeline pressure monitored by at least one pressure sensor of a plurality of pressure sensors maintains a preset pressure threshold for a preset duration (e.g., 5 min, etc.), and the pressure change rate is lower than other pressure sensors by a preset magnitude (e.g., 30%, etc.). The preset pressure threshold, the preset duration, or the preset magnitude may be set by the user.

In some embodiments of the present disclosure, by monitoring pressure at a plurality of points, not only can completion of vacuum pumping be determined, but also local leakage can be diagnosed. When pressure at a certain point is abnormal, an alarm may be issued in advance to avoid putting a pipeline with leakage risk into a subsequent low-temperature precooling process, thereby preventing safety hazards caused by ice blockage or pressure accumulation.

In some embodiments of the present disclosure, by long-term monitoring for the existence of local abnormalities and issuing abnormal alarms, thereby alerting operators to leakage risks, it is possible to avoid introducing expensive liquid hydrogen into a potentially problematic pipeline in the next stage, thus preventing invalidation of calibration, loss of cooling capacity, or even safety accidents due to liquid hydrogen leakage, thereby saving time and resources.

In some embodiments of the present disclosure, by monitoring the dynamic parameter of the pressure change rate, the stage of the evacuation process may be intelligently perceived. When the pressure change rate gradually decreases and stabilizes, it indicates a transition from a rapid pumping stage to an ultimate vacuum approaching stage, where most of the gas in the pipeline has been removed and subsequent pumping efficiency is extremely low. The controller controls the pumping device to automatically stop vacuum pumping at this moment, which can avoid ineffective or inefficient operation after the performance inflection point, prevent prolonged high-load idling of the vacuum pump, significantly save power consumption, and reduce mechanical wear of the pump body, thereby extending the service life of the device.

FIG. 7 is a schematic diagram illustrating an exemplary prediction model according to some embodiments of the present disclosure.

In some embodiments, as shown in FIG. 2, the device 100 further includes: a temperature sensor (a first temperature sensor 415 and a second temperature sensor 416), wherein the first temperature sensor 415 is disposed on an inlet pipe 402 of the tested pipeline cold box, and the second temperature sensor 416 is disposed on an outlet pipe 403 of the tested pipeline cold box.

In some embodiments, the temperature sensor is configured to obtain temperature data.

The temperature data refers to temperature values of the inlet pipe 402 of the tested pipeline cold box and the outlet pipe 403 of the tested pipeline cold box within a preset period, and may provide input information for the prediction model 730.

In some embodiments, as shown in FIG. 4, the device 100 further includes a second liquid hydrogen pump 701 and a second controller (not shown in the figure). The second liquid hydrogen pump 701 is a variable speed pump. The second controller is communicatively connected to the temperature sensor and the second liquid hydrogen pump 701. The second controller is configured to periodically update a rotational speed of the second liquid hydrogen pump 701, and execute, within at least one cycle: as shown in FIG. 7, based on temperature data 710 within a preset period and a current rotational speed 720 of the second liquid hydrogen pump 701, a cooling power output curve 750 of the second liquid hydrogen pump 701 is predicted through a prediction model 730, wherein the prediction model 730 is a machine learning model. The prediction model 730 includes a temperature sub-model 731 and a power sub-model 732. The temperature sub-model 731 determines a future temperature change rate 740 of the tested pipeline based on the temperature data 710 and the current rotational speed 720. The power sub-model 732 determines the cooling power output curve 750 based on the future temperature change rate 740. The second liquid hydrogen pump 701 is adjusted to control a cooling power based on the cooling power output curve 705.

The rotational speed of the second liquid hydrogen pump 701 refers to an execution variable obtained by the prediction model, which is tightly coupled with the temperature data and is dynamically and periodically adjusted by the second controller to achieve precise temperature control of the tested pipeline cold box 401.

In some embodiments, the second liquid hydrogen pump 701 is a variable speed pump, which may pump a required amount of liquid hydrogen according to cooling demand. For more description about the second liquid hydrogen pump 701, refer to FIG. 1-FIG. 4 and related description.

The second controller refers to a control unit used to implement an optimal precooling process, and the second controller is communicatively connected to the temperature sensor and the second liquid hydrogen pump 701. In some embodiments, the second controller receives the temperature data 710 obtained by the temperature sensor, makes decisions through the prediction model 730, and controls the rotational speed of the second liquid hydrogen pump 701 to adjust the cooling power within at least one cycle based on a result obtained from the prediction model 730.

The second controller is similar to the first controller, with the difference being that they are connected to different devices in the device 100 and are used to control different devices. More description about the first controller may be found in FIG. 6 and the related description.

The cycle refers to a time period during which the prediction model predicts and outputs the cooling power output curve, and the second controller adjusts the rotational speed of the second liquid hydrogen pump based on the cooling power output curve output by the prediction model. A cycle length may be preset by the user as needed.

The temperature data 710 of the preset period refers to temperature measurement values collected by the temperature sensor communicatively connected to the second liquid hydrogen pump 701. The preset period refers to an interval that ends at a current time and extends backward for a fixed time length, and the time length of the preset period is the time length of one cycle.

The current rotational speed 720 refers to a real-time rotational speed value at which the second liquid hydrogen pump 701 is actually operating. The current rotational speed is obtained by the second controller. The current rotational speed 720 is related to a currently operating cooling power.

The cooling power output curve 750 refers to a curve of the cooling power of the second liquid hydrogen pump 701 changing over time within a future preset period from the current moment. A length of the preset period may be set by the user as needed.

The prediction model 730 refers to a model used to determine the cooling power output curve 750, thereby enabling the second controller to adjust the cooling power. In some embodiments, the prediction model is a machine learning model. For example, the prediction model may include a Deep Neural Network (DNN), or other custom model structures, or any combination thereof.

The prediction model may be obtained through a large count of first training samples with first labels. A set of first training samples may include sample temperature data and a sample rotational speed, and a corresponding first label may include a sample cooling power output curve corresponding to the set of first training samples.

The first training samples may be determined based on historical data. Each set of first training samples includes historical temperature data and a historical rotational speed within a historical preset period. For each set of first training samples, a historical cooling power output curve corresponding to a cooling power that causes the temperature change of the tested pipeline to return to a target temperature within a period following the historical preset period (e.g., an Integral of Squared Error (ISE) between a temperature curve and a target cooling curve is less than a threshold) is determined as the first label.

In some embodiments, the user may input a plurality of first training samples with first labels into an initial prediction model. A loss function is constructed based on the first labels and an output result of the initial prediction model. Parameters of the initial prediction model are iteratively updated based on the loss function through gradient descent or other manners. When an iteration condition is satisfied, model training is completed, and a trained prediction model 730 is obtained. The iteration condition may be that the loss function converges, a count of iterations reaches a threshold, etc.

In some embodiments, the prediction model 730 includes a temperature sub-model 731 and a power sub-model 732. An input of the temperature sub-model 731 is the temperature data 710 and the current rotational speed 720, and an output of the temperature sub-model 731 is the future temperature change rate 740. An input of the power sub-model 732 is the future temperature change rate 740, and an output of the power sub-model 732 is the cooling power output curve 750.

The future temperature change rate 740 refers to a future temperature change situation of the tested pipeline.

The temperature sub-model may be obtained through a large count of second training samples with second labels. A set of second training samples may include sample temperature data and sample rotational speed. A corresponding second training label may include a sample temperature change rate corresponding to the set of second training samples.

The second training samples and the second labels may be determined based on historical data. Each set of historical data includes historical temperature data and a historical rotational speed in a first time period. For each set of second training samples, the user may determine an actual historical temperature change rate in a second time period as the second training label. The first time period is earlier than the second time period.

A training manner of the temperature sub-model is similar to the training manner of the prediction model described above. More descriptions may be found in the relevant description above.

The power sub-model may be obtained through a plurality of third training samples with third labels. A set of third training samples may include a sample temperature change rate. A corresponding third label may include a sample cooling power output curve corresponding to the set of third training samples.

The third training samples and the third labels may be determined based on simulation experiments. The user may simulate and obtain different sample temperature change rates through experiments. By adjusting a cooling power of the second liquid hydrogen pump 701, a temperature change of the tested pipeline returns to a target temperature in a historical period (e.g., an integral of squared error (ISE) between a temperature curve and a target cooling curve is less than a threshold). A cooling power output curve applied at this time is determined as the third label. The historical period may be set by the user according to requirements.

A training manner of the power sub-model is similar to the training manner of the temperature sub-model. More descriptions may be found in the relevant description above. In some embodiments, the user may use the prediction model to predict a temperature change trend of the tested pipeline, thereby dynamically adjusting the cooling power according to a predicted future temperature change rate 740.

For example, the user may arrange temperature sensors on an inlet pipe 402 of the tested pipeline cold box and an outlet pipe 403 of the tested pipeline cold box to obtain heat taken away per unit time through a temperature difference, i.e., a real-time cooling power. A temperature sensor is arranged on the tested flow meter to continuously monitor a temperature change rate of the flow meter, and a cooling power is reduced in advance in combination with a prediction of a thermodynamic model. A temperature change trend of the inlet pipe 402 of the tested pipeline cold box and the outlet pipe 403 of the tested pipeline cold box is predicted through a thermodynamic model such as a heat conduction model. A required cooling power is determined according to a real-time temperature. A liquid hydrogen flow of the second liquid hydrogen pump 701 is dynamically adjusted according to the required cooling power.

In some embodiments, an input of the temperature sub-model further includes structural parameters of the tested flow meter and the supporting pipeline, and the structural parameters include at least one of a pipe diameter, a length, a wall thickness, or a surface area. More description about the tested flow meter and the supporting pipeline may be found in the relevant description above.

The structural parameter refers to a dimensional parameter related to the tested flow meter and the supporting pipeline. The structural parameters include at least one of a pipe diameter, a length, a wall thickness, or a surface area of the tested flow meter and the supporting pipeline.

In some embodiments, the structural parameter may be determined by the user based on design drawings and specification documents, or may be determined through measurement.

In some embodiments of the present disclosure, by inputting the structural parameters of the tested flow meter and the supporting pipeline into the prediction model, a precooling strategy can adapt to flow meters of different types and sizes. Therefore, while ensuring that one set of facility achieves universal verification, preciseness and efficiency of a precooling process are ensured, and a result is more suitable for an actual application scenario.

In some embodiments, the second controller adjusts a rotational speed of the second liquid hydrogen pump to a required rotational speed corresponding to the cooling power based on a cooling power output curve output by the prediction model, to perform precise cooling.

In some embodiments of the present disclosure, by introducing intelligent predictive control based on the prediction model, an advance, precise, and adaptive adjustment of the cooling power is achieved. The tested pipeline is cooled at the fastest speed, a waiting time of the device 100 is minimized to a maximum extent, and cooling efficiency is improved. Precise adjustment of the cooling power avoids energy waste, a precooling process is completed with a minimum liquid hydrogen consumption, and verification cost is significantly reduced.

The foregoing describes the specific implementations of the present disclosure with reference to the accompanying drawings. However, these descriptions should not be construed as limiting the scope of the present disclosure. The protection scope of the present disclosure is defined by the accompanying claims. Any modification made on the basis of the claims of the present disclosure falls within the protection scope of the present disclosure.

What is claimed is:

1. A device for quickly replacing a tested flow meter in a liquid hydrogen flow measurement standard facility, comprising:
a tested cold box, wherein the tested flow meter is located in the evacuated tested cold box, and the tested cold box is connected to the liquid hydrogen flow measurement standard facility through a bayonet structure;
a first vacuum pump, configured to evacuate the tested cold box after replacing the tested flow meter;
a second vacuum pump, configured to evacuate a tested pipeline; wherein the tested pipeline is a pipeline formed by connecting a first vacuum bellow, an inlet pipe of a tested pipeline cold box, a supporting pipeline of the tested flow meter, an outlet pipe of the tested pipeline cold box, and a second vacuum bellow in series; a first liquid hydrogen refueling coupler female connector and a second liquid hydrogen refueling coupler female connector are respectively connected to the first vacuum bellow and the second vacuum bellow through flanges to form a liquid hydrogen standard flow during calibration; a connector on the second vacuum pump is in a form of a liquid hydrogen refueling couple male connector, and the connector on the second vacuum pump is connected to the first liquid hydrogen refueling coupler female connector when evacuating the tested pipeline;
a precooling device, configured to precool the tested pipeline and the tested flow meter connected to the tested pipeline after the tested pipeline is evacuated.

2. The device of claim 1, wherein the tested flow meter and the supporting pipeline are connected to the inlet pipe and the outlet pipe of the tested cold box using the flanges.

3. The device of claim 2, wherein a first liquid hydrogen refueling female male connector and a second liquid hydrogen refueling male connector are connected to a pipeline cold box in the liquid hydrogen flow measurement standard facility through respective vacuum sleeve tubes.

4. The device of claim 1, wherein after a plurality of tested flow meters are connected through respective supporting pipelines, a length of each of the plurality of tested flow meters and its supporting pipeline is the same as a reserved pipeline length in the tested pipeline cold box, thereby achieving calibration of flow meters from different manufacturers within a same caliber range.

5. The device of claim 1, further comprising: a pressure sensor, disposed on the inlet pipe of the tested pipeline cold box and/or the outlet pipe of the tested pipeline cold box, wherein the pressure sensor is configured to monitor a pipeline pressure and a pressure change rate in the tested pipeline in real time;
a solenoid valve, disposed on a pipeline of the second vacuum pump; and
a first controller, communicatively connected to the pressure sensor and the solenoid valve, and configured to: in response to the pipeline pressure and the pressure change rate satisfying a first preset condition, control the solenoid valve to close to stop evacuation; wherein the first preset condition is that the pipeline pressure is higher than a target pressure value and the pressure change rate is lower than a rate change threshold.

6. The device of claim 5, wherein a plurality of the pressure sensors are provided and distributed at at least two positions among the inlet pipe of the tested pipeline cold box, within a preset distance of the tested flow meter, and the outlet pipe of the tested pipeline cold box; and
the first controller is further configured to: in response to a plurality of pipeline pressures and a plurality of pressure change rates monitored by the plurality of pressure sensors satisfying the first preset condition, control the solenoid valve to close to stop the evacuation.

7. The device of claim 6, further comprising: a user terminal, wherein the user terminal is configured to push an abnormal alarm message to a user;
the first controller is further configured to: in response to the plurality of pipeline pressures and the plurality of pressure change rates satisfying a second preset condition, trigger the first controller to send the abnormal alarm message to the user terminal.

8. The device of claim 1, further comprising: a temperature sensor, disposed on the inlet pipe of the tested pipeline cold box and/or the outlet pipe of the tested pipeline cold box, wherein the temperature sensor is configured to obtain temperature data;
a second liquid hydrogen pump, wherein the second liquid hydrogen pump is a variable speed pump;
a second controller, communicatively connected to the temperature sensor and the second liquid hydrogen pump, wherein the second controller is configured to periodically update a rotational speed of the second liquid hydrogen pump, and execute in at least one cycle:
predicting, based on temperature data within a preset period and a current rotational speed of the second liquid hydrogen pump, a cooling power output curve of the second liquid hydrogen pump through a prediction model, wherein the prediction model is a machine learning model; the prediction model includes a temperature sub-model and a power sub-model; the temperature sub-model determines a future temperature change rate of the tested pipeline based on the temperature data and the current rotational speed; the power sub-model determines the cooling power output curve based on the future temperature change rate; and
adjusting the second liquid hydrogen pump to control a cooling power based on the cooling power output curve.

9. The device of claim 8, wherein an input of the temperature sub-model further includes structural parameters of the tested flow meter and the supporting pipeline, and the structural parameters include at least one of a pipe diameter, a length, a wall thickness, or a surface area.

10. A method for quickly replacing a tested flow meter, applicable to a liquid hydrogen flow measurement standard facility, using the device of claim 1, comprising:
after completing calibration of a tested flow meter and before calibrating a next tested flow meter, disconnecting a tested pipeline cold box from the liquid hydrogen flow measurement standard facility through a bayonet structure;
after replacing the tested flow meter and a supporting pipeline, evacuating the tested pipeline cold box;
evacuating a tested pipeline; and
precooling the tested pipeline and the tested flow meter connected to the tested pipeline.

11. The method for quickly replacing the tested flow meter of claim 10, wherein disconnecting the tested pipeline cold box from the liquid hydrogen flow measurement standard facility through a bayonet structure includes: disconnecting a connection between a male connector and a female connector of a first liquid hydrogen refueling and a second liquid hydrogen refueling in the liquid hydrogen flow measurement standard facility.

12. The method for quickly replacing the tested flow meter of claim 10, wherein the precooling is performed by: connecting the tested cold box to both sides of a large liquid hydrogen storage tank, and pumping liquid hydrogen into the tested pipeline through a second liquid hydrogen pump on a pipeline.

13. The method for quickly replacing the tested flow meter of claim 10, further comprising:
monitoring a pipeline pressure and a pressure change rate in the tested pipeline in real time;
in response to the pipeline pressure and the pressure change rate satisfying a first preset condition, controlling the solenoid valve to close to stop evacuation; wherein the first preset condition is that the pipeline pressure is higher than a target pressure value and the pressure change rate is lower than a rate change threshold.

14. The method for quickly replacing the tested flow meter of claim 13, further comprising: in response to a plurality of pipeline pressures and a plurality of pressure change rates monitored by the plurality of pressure sensors satisfying the first preset condition, controlling the solenoid valve to close to stop the evacuation.

15. The method for quickly replacing the tested flow meter of claim 14, further comprising:
in response to the plurality of pipeline pressures and the plurality of pressure change rates satisfying a second preset condition, triggering the first controller to send the abnormal alarm message to the user terminal.

16. The method for quickly replacing the tested flow meter of claim 10, further comprising: periodically updating a rotational speed of a second liquid hydrogen pump, and executing in at least one cycle:
predicting, based on temperature data within a preset period and a current rotational speed of the second liquid hydrogen pump, a cooling power output curve of the second liquid hydrogen pump through a prediction model, wherein the prediction model is a machine learning model; the prediction model includes a temperature sub-model and a power sub-model; the temperature sub-model determines a future temperature change rate of the tested pipeline based on the temperature data and the current rotational speed; the power sub-model determines the cooling power output curve based on the future temperature change rate; and
adjusting the second liquid hydrogen pump to control a cooling power based on the cooling power output curve.

17. The method for quickly replacing the tested flow meter of claim 16, wherein an input of the temperature sub-model further includes structural parameters of the tested flow meter and the supporting pipeline, and the structural parameters include at least one of a pipe diameter, a length, a wall thickness, or a surface area.
